(19) United States
(12) Patent Application Publication
(10) Pub. No.: US 2010/0131764 A1
(43) Pub. Date: May 27, 2010

(54) SYSTEM AND METHOD FOR SECURED DATA TRANSFER OVER A NETWORK FROM A MOBILE DEVICE

(75) Inventor: Chuan Iau Goh, Singapore (SG)

Correspondence Address: KNOBBE MARTENS OLSON & BEAR LLP, 2040 MAIN STREET, FOURTEENTH FLOOR, IRVINE, CA, 92614, US

(73) Assignee: Ezypay PTE Ltd, Singapore (SG)

(21) Appl. No.: 12/598,396

(22) PCT Filed: Apr. 30, 2008
(86) PCT No.: PCT/SG08/00147

§ 371 Date: Oct. 30, 2009

(30) Foreign Application Priority Data
May 3, 2007 (SG) 200703161-0

(51) Int. Cl. H04L 9/32

(52) U.S. Cl. 713/171

(57) ABSTRACT

A secured data transfer system (10) and method is disclosed in accordance with an embodiment of the invention that enables sensitive data to be securely exchanged from a user/client's mobile device (12), phone, personal digital assistant (PDA), or the like to a back-end host (28), flowing through many hops and points in an public network, for example the Internet and/or in applications such as service provider's wireless networks, without being exposed to any security gaps in between servers. The system and method provides a secure solution that plugs the gaps and ensures a true end-to-end, bank-grade secured transaction exchange between the user/client's mobile device (12) and the back-end host (28) and using caching method for network traffic data reduction techniques.

### TECHNICAL FIELD

This invention relates to a secure system and method of exchanging information and transaction over the public telecommunications network, and more particularly, for transactions related to secured information, banking, payments, and transferring of funds conducted over a public network, such as the Internet.

### BACKGROUND OF THE INVENTION

In any financial transaction, security is of utmost importance. Any sensitive data like personal identification number (PIN) or password must to be transmitted securely between the mobile input devices and the financial institution's host. The integrity, confidentiality and authenticity of the transaction and initiator have to be properly addressed. In recent years, the slow adoption of mobile banking and commerce over the air, i.e. wireless networks and applications, has attributed to the insufficient security to consumers, merchants, and the financial institutions. Most of the mobile banking and commerce falls into limited intra-banking and micro payment space using short message services (SMS) transactions or general packet radio service (GPRS) over wireless transport layer security (WTLS). These limitations in these technologies definitely do not offer the kind of security required by financial institutions and other regulatory bodies for full funds movements and payments potential.

Advancing from an unsecured open clear text SMS to standard wireless secure socket layer (SSL), WTLS environments, even with the secured signed keys issued by certified authority, the SSL sessions in between servers are exposed to data hacking as there is an area of clear data exposure when the SSL sessions are translated from one secured link to another. These secure gaps are unacceptable for a truly end-to-end secured data exchange. In the communication environments like global system for mobile communication (GSM), GPRS, or 3G/3.5G, the clear data exposure is very real as the WTLS session needs to flow through many third party hops/hubs which are out of the financial institution's host's control. Beside the security gaps that exist in GPRS and 3G/3.5G network, the cost of traffic usage is another deterrent for adoption. The transaction exchange method must provide a way to reduce the amount of traffic between the user's device and the operator servers for it to be commercially viable for adoption.

There is a need for a cost effective and secured mobile transaction exchange system and method that improves end-to-end security, with minimum network traffic exchanges, to meet the banking requirements for conducting commercially viable financial transactions securely over a public network.

### SUMMARY OF THE INVENTION

In accordance with an aspect of the invention there is provided a method for end-to-end secure data transfer between a mobile device of a user and a server via an insecure network to a target domain, the method comprising downloading a midlet from the server to mobile device; authenticating a user of the mobile device in a transaction authentication; generating a server key at the application server comprising a server seed and a target-device key-pair received from the target domain, transmitting the device key to the mobile device via the midlet; receiving data input from the user at the mobile device; generating a client seed at the mobile device and encrypting the data input with device key and client seed at the mobile device and transmitting the encrypted data input encoded and/or padded with client seed to application server; decrypting the encrypted data input using server key; and translating the decrypted data input using target key within a hardware security module without exposing the encrypted data input to the network and transmitting the translated data input to the target domain.

In an embodiment the method may further comprise downloading a midlet from the server to the mobile device; and generating a server seed at the server; and loading the midlet with the server seed and a transaction identifier. The method may further comprise generating a dynamic key and a seed exchange and management during the transaction between the user and the established target institution, for example, to enable a telco agnostic with multiple secured domains from a single mobile client application to established target institutions. The method may further comprise generating a static public key with validity periods between the user and established target institution. The method may have a SMS channel. The user key may be an RSA public key, and loading the user key onto the midlet at input of encrypting data upon midlet. The server seed and the transaction identifier are session based. Authenticating the user may comprise locating the transaction status of the transaction identifier. The method may further comprise generating a dynamic client seed; and verifying the client seed is with the encoded data over the session period. The method may further checking a server seed stored in the server matches the server seed derived from the encrypted data. The method may further comprise synchronizing the midlet of the mobile device with the server informing the server of page information of cached pages on mobile device; and generating a page footprint for updating uncached pages. The midlet may be in SMS mode and the synchronizing is instigated upon the page access or by a user manual activation.

In accordance with an aspect of the invention there is provided a system for end-to-end secure data transfer between a mobile device of a user and a server via an insecure network to a target domain, the system comprising a downloading module for downloading a midlet from the server to mobile device; an authenticating module in the server for authenticating a user of the mobile device in a transaction authentication; a server key module for generating a server-device key-pair at the application server comprising a server seed and a device key received from the server domain, transmitting the device key to the mobile device via the midlet; a data input module for receiving data input from the user at the mobile device; an encrypting module generating a client seed at the mobile device and encrypting the data input with device seed and client seed at the mobile device and transmitting the encrypted data input encoded and/or padded with client seed to application server; a decrypting module on the application server for decrypting the encrypted data input using server key; and a translator for translating the decrypted data input using target key within a hardware security module without exposing the encrypted data input to the network and transmitting the translated data input to the target domain.

In an embodiment the authenticating module further comprising a key module for generating a dynamic key and a seed exchange and management during the transaction between the user and the established target institution to enable a telco agnostic with multiple secured domains from a single mobile client application to established target institutions. The system may further comprise a downloading module for downloading a midlet from the server to mobile device; and a seed module within the server to generate a server seed; and loading the midlet with the server seed and a transaction identifier. The key module may further comprise generating a static public key with validity periods between the user and established target institution. The system may further comprise a

SMS channel. The user key may be an RSA public key, and loading the user key onto the midlet at input of encrypting data upon midlet, and the server seed and the transaction identifier are session based. The authenticating module may authenticate the user comprises locating the transaction status of the transaction identifier. The authenticating module may further comprise generating a dynamic client seed; and verifying the client seed is with the encoded data over the session period. The authenticating module may further comprise checking a server seed stored in the server matches the server seed derived from the encrypted data. The system may further comprise a synchronizing module for synchronizing the midlet of the mobile device with the server informing the server of page information of cached pages on mobile device; and generating a page footprint for updating uncached pages. The midlet may be in SMS mode and the synchronizing is instigated upon the page access or by a user manual activation

In accordance with an aspect of the invention there is provided a midlet for enabling a system for end-to-end secure data transfer between a mobile device of a user and an application server via an insecure network to a target domain, the midlet for downloading from the server to the mobile device, comprising a server interface for interfacing with the server and a user interface for interfacing with the user of the mobile device, an authenticating module for authenticating the user of the mobile device in a transaction authentication; the server interface for communicating with a server key module for generating a server key at the application server comprising a server seed and a server-device key-pair generated from the server domain, transmitting the device key to the mobile device via the midlet; the user interface for receiving at a data input module data input from the user at the mobile device; the server interface for enabling an encrypting module generating a client seed at the mobile device and encrypting the data input with device key, encode and/or padded with client seed at the mobile device and transmitting the encrypted data input with client seed to application server, and a decrypting module on the application server for decrypting the encrypted data input using server key; and a translator module on the application server for translating the decrypted data input using target key within a hardware security module without exposing the encrypted data input to the network and transmitting the translated data input to the target domain.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 shows a block diagram of a system in accordance with an embodiment of the invention;

FIG. 2 shows a block diagram of a system in accordance with an embodiment of the invention;

FIG. 3 shows a timing sequence of a method and system in accordance with an embodiment of the invention;

FIG. 4 shows a block diagram of the end to end security flow of a system in accordance with an embodiment of the invention;

FIG. 5 is a block diagram of message transformation in a system in accordance with an embodiment of the invention;

FIG. 6 is a table listing the tags in the XML files as defined in a system in accordance with an embodiment of the invention;

FIG. 7 is a table listing the internal message formal field in a system in accordance with an embodiment of the invention;

FIG. 8 is a flow chart of midlet-3 or 3.5G and GPRS cache flow in a system in accordance with an embodiment of the invention; and

FIG. 9 is a flow chart of midlet-SMS cache flow in a system in accordance with an embodiment of the invention.

### DETAILED DESCRIPTION OF THE PREFERRED EMBODIMENTS

A system and method for secured mobile payment and secure transactions is disclosed.

In the following description, for the purposes of explanation, numerous specific details are set forth in order to provide a thorough understanding of the present invention. It is apparent to one skilled in the art, however, that the present invention may be practiced without these specific details or with equivalent arrangements. In some instances, well-known structures and devices are shown in block diagram form in order to avoid unnecessarily obscuring the present invention. A system is disclosed and shown in FIG. 1 in accordance with an embodiment of the invention that enables a data to be securely exchanged from a mobile device 12, phone, PDA, or the like to a back-end host 28, flowing through many hops and points with key translation done by HSM 26 without being exposed to any software security gaps in between servers. The mobile solution plugs the gaps and ensures a true end-to-end, bank-grade secured transaction exchange between the client 12 and the back-end host 28.

In accordance with an embodiment secure data transfer is made between a mobile device of a user and a server via an insecure network to a target domain, the method comprising authenticating user; encrypting data upon input at a secured application loaded on the user's known as device “midlet” on the mobile device of the user, encrypting with a user key, transmitting the encrypted data through the network to a target domain via a server; translating data with operator key and institution key within a hardware security module (HSM). Integrating the encrypting and decrypting within the HSM ensures that the end-to-end secured envelop is not exposed to any possible security software gap along the entire transaction life cycle. Embodiments of the invention of this process span across the entire telecommunication network infrastructure of SMS, GPRS, 3, 3.5G, or the like channels. A midlet is a JAVA program for embedded devices such as for mobile devices like mobile telephones and the like, that run on JAVA 2 PLATFORM MICRO EDITION (J2ME). J2ME and JAVA are registered trademarks in the United States and other countries of Sun Microsystems, Inc. of Santa Clara, Calif., United States of America.

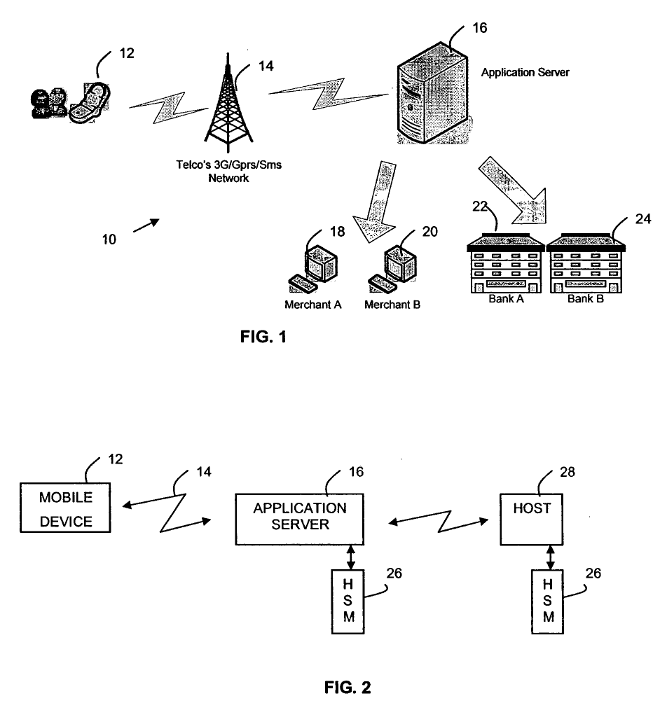

FIG. 1 and FIG. 2 show the high-level components that are associated with a secured mobile payment system 10. A public key encryption RSA-browser midlet 12 is downloaded from the application server 16 via the 3G/3.5G/GPRS/SMS or the like network 14 into the users' mobile devices, which could be a wireless personal digital assistant (PDA), mobile phone or the like. The midlet acts as a secured client channel to the back-end institution to execute various services and transmit sensitive information in an encrypted transaction envelope. Cryptograms that may be implemented may include, for example, Standard RSA, data encryption standard (DES), triple DES (3DES), advanced encryption standard (AES), optimal asymmetric encryption padding (OAEP) with RSA, Feistel cipher network, or the like.

As an example of a secured banking service, Midlet synchronizes and communicates with an application or gateway server, which in turn may be connected to financial institutions/merchants/banks 18,20,22,24 for financial transactions via network 14. Embodiments of the secured mobile payment system may be configured in standard wireless SSL (WTLS) environments, where the exposed clear-data in SSL sessions in between servers are plugged to prevent clear-data exposure when the SSL sessions are translated from one secured link to another. Also, embodiments of the secured mobile payment system may be configured in the GSM/GPRS/3G/3.5G environment, where clear-data exposure is prevented in the WTLS session flows through many third party hops/hubs which are out of the institutions' control.

By employing industry recognized security standards, namely for example Standard RSA, 3DES, AES cryptology algorithms, which are widely accepted and adopted by banks, embodiments of the secured mobile payment system 10 is able to provide a secured end to end transmission for sensitive transaction which involves data such as PIN, password and credit card information, and connected to existing core banking systems without major revamping of the financial institutions' authorization processes. The security features encompass a set of challenges between the application server and midlet for device and user authentication and verification so that the encrypted data envelop can not be replayed, emulated, or hacked by employing a caching and synchronization technique described below in more detail for an efficient, fast and data reduction techniques in loading of dynamic menus items over the air (OTA), i.e. wireless applications such as wireless networks, to the mobile devices. These techniques of dynamic keys and items synchronization enable the service to be independent of telephone companies' (telco)'s security information management (SIM)/software development kits (SDK) or the specific institution's key lock-in, thereby catering to service multiple telcos and financial institutions.

An embodiment of the secured mobile payment system may be transacted in both 3G/3.5G/GPRS and short message service (SMS) modes. With this configuration, the service is accessible, for example such as when a user is on auto-roam subscription. In an embodiment, the development platform may be for example J2ME: Wireless Toolkit 2.3 and above, and Polish: Polish 1.4 and above. The device platform may be for example JAVA enabled Mobile Information Device Profile (MIDP) 2.0 and above on mobile devices and phones.

I. Security and Authentication Description

An embodiment of the secured mobile payment system 10 security implementation shown in FIG. 1 and FIG. 2 provides and addresses the transaction security, specifically, end to end sensitive data, for example password, PIN, or the like, security; user authentication; and session authentication. End to end security creates a secured domain between the user's mobile device or phone 12, through the application server 16 via a network 14 and finally to the financial institution's 18,20,22,24 hardware security module (HSM) 26.

Within this secured domain, the data, for example password, PIN, or credit card number, is encrypted right upon input at the midlet on the mobile device 12, and transmitted in an encrypted form all the way to the financial institution's HSM 26. At the operator's gateway server, the HSM 26 in the application server 16 performs a key translation between the operator's key to the financial institution's key, such that the encrypted data's map from one operator's secured domain to the financial institution's secured domain. As the entire keys and encrypted data translation is executed within a HSM 26, which is a secured and temper-resistant hardware device, the sensitive data is never exposed in the clear except throughout the entire transaction flow cycle of the message. This technique plugs the security gap exposure that exists in standard WTLS/SSL configuration that flows through multiple hops and gateway sites.

The secured mobile payment system end-to-end secured exchange protects the confidentiality to the user's data as it passes through third parties servers. User authentication ensures the authenticity of the transaction by verifying that the transaction initiator is an authorized user. Session authentication prevents replay attack and ensures the integrity of the transmitted message.

II. Secured Session Synchronization Descriptions

The secured mobile payment system provides end to end transaction security by employing bank-grade, that is for example end-to-end encryption without any security gap or software translation exposure of sensitive data within entire transaction cycle, session control and recognized encryption standards, such as for example Standard RSA, DES, 3DES, AES, OAEP-RSA, Feistel cipher network, or the like as mentioned above. Such may be used for user authentication, for example to ensure the right user matches the right account or device; session authentication, for example to ensure the transaction received is authentic and from a authorize device or source; and sensitive transaction data, for example PIN, are encrypted using encryption algorithms such as standard or other encryption algorithms such as optimal asymmetric encryption padding (OAEP)-RSA encryption algorithm or the like.

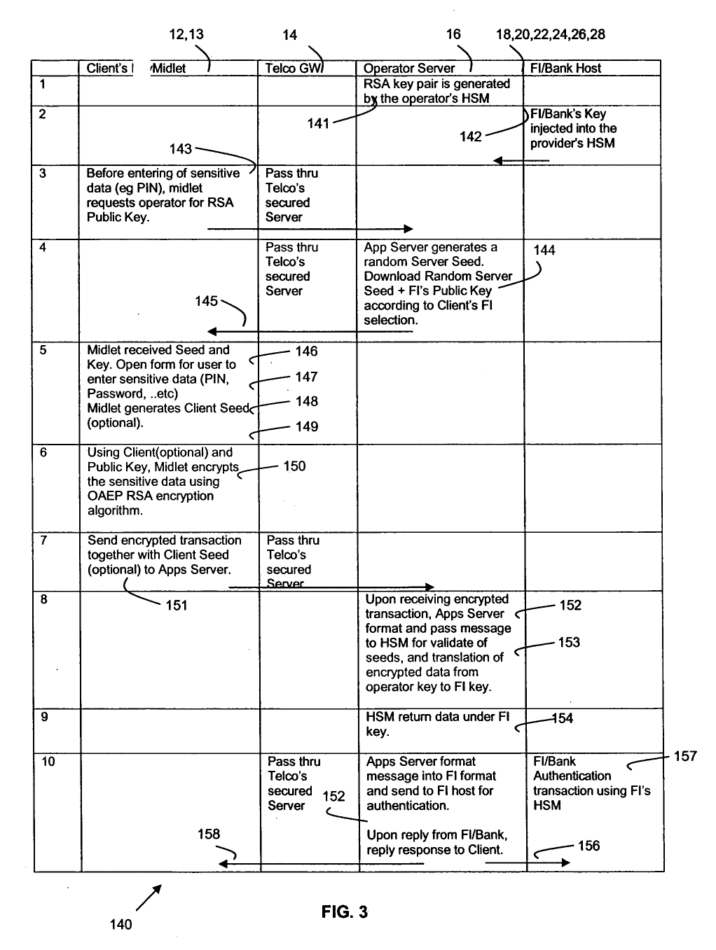

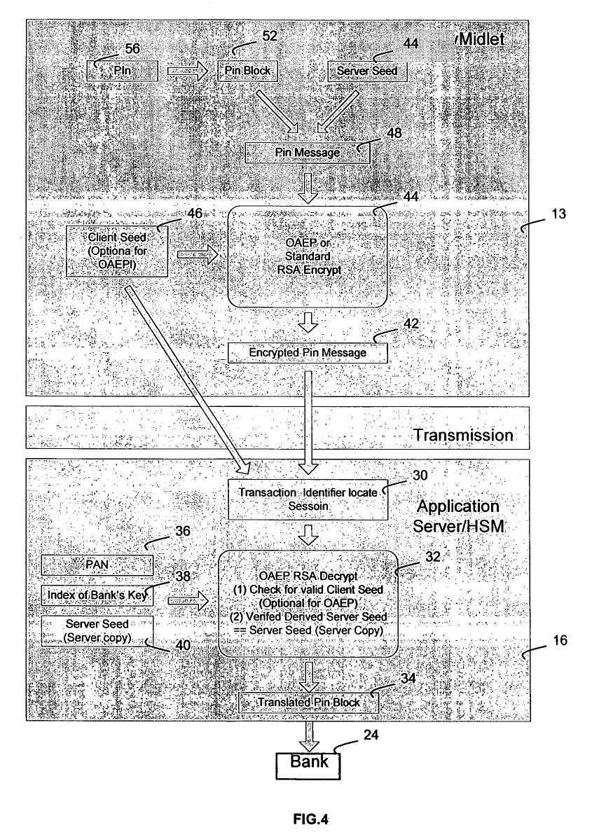

In an embodiment, as shown in FIG. 3 and FIG. 4, illustrating the end to end security flow 140,160, a RSA key pair is generated 141 by the application/operator server 16 using the

HSM 26. The financial institution/bank's 18,20,22,24 key is injected into the provider's HSM 142. The RSA public key, together with a server seed 50 and a transaction identifier 30 is loaded onto the midlet when midlet request for the loading of the transaction page. The transaction page is the page which requires the input of a PIN and other sensitive data 56.

Before entering the sensitive data, for example PIN, by the user, the midlet requests the application/operator server for RSA public key 143. The request is transmitted through the secured server of the server provider network 14 to the application server 16. The application server generates a random server seed 144, and then downloads 145 the random server seed 50 and the financial institution/bank's public key according to the client/user's 12 selection of financial institution/bank transmitted through the secured server of the server provider network 14 to the client/user. The RSA public key and server seed are sent to the midlet. The midlet receives 146 the seed and key from the application server 16 and opens 147 a form on the user interface for the user to enter 148 the sensitive data such as PIN 56, password and the like. At this point the midlet may additionally generate 149 a client seed 46. Using the public key, and/or the client seed which may or may not be generated, the midlet encrypts 150 the sensitive data, such as PIN message 48, using for example OAEP-RSA encryption algorithm 44. The sensitive data is encrypted with the device key, encode and/or padded with client seed. The encrypted transaction, such as encrypted PIN message 42, is transmitted 151 together with the client seed if the client seed was generated to the application server 16 through the secured server of the server provider network 14.

Upon receiving the encrypted transaction the application server 16 formats and transmits the message to the HSM. The HSM validates seeds and translates 153 the encrypted data, for example translated PIN block 34, from the operator key to the financial institution/bank key. The HSM may have an index of bank's keys 38, PAN 36 and server seed, server copy 40. The HSM, for example OAEP-RSA decrypts the encrypted sensitive data, for example RSA private key, by checking for valid client seed, which may be optional for OAEP-RSA, and/or verify derived server seed matches the server seed of the server copy 32. The HSM returns data 154 to the application server under the financial institution/bank key. The HSM of the application server encrypts the sensitive data using financial instruction/banks key. The application server 16 formats 155 the message into financial institution/bank format and transmits 156 the translated sensitive data, such as PIN, to the financial institution/bank host 28 for authentication. The financial institution /bank 18,20,22,24 authenticates 157 the transaction using the financial institution/bank's HSM. Upon reply from the financial institution/bank the application server transmits 158 reply response to the client/user 12 via the secured server of the server provider network 14.

In an embodiment, a server seed 50 is a random number which is used for message integrity and to prevent replay attack. Transaction identifier is also a transaction number which is used together with the phone number to uniquely identify a transaction by the application server. Both the server seed and transaction identifier are session based. In other words, both the server seed and the transaction identifier are dynamically generated and are different for each session of transaction. For added message integrity, a message authentication checksum (MAC) may also be computed and included to the message between the servers and the device midlet.

An embodiment of the secured mobile payment system supports OAEP 44 with random client seed 46, standard without client seed RSA encryption algorithm, or the like, depending on the financial institution's/bank's requirements.

III. Client processing (with midlet)

In an embodiment of the invention a thin client application, called midlet, is loaded into the mobile device, which enables the user to transact through multiple telecommunication networks and yet maintain the secured domain with multiple financial institutions' key-pairs. The midlet establishes secured domain channels, with session keys management and cache management, between the registered users with the participating institutions. The midlet contains a generic public key for connecting to the operating or hosting site. But the actual key-pairs between the user's device and the transacted institution are dynamically loaded during the live session. However, for higher efficiency and lower cost implementation, institutions' key-pair may be pre-loaded with specific validity period within the midlet. Key exchange may be done only upon expiry of the pre-loaded public key for each participating institution.

To protect the integrity of the encrypted data, the server seed 50, as described above, which is a random number generated by the application server HSM 26 and stored in the server with a time limit waiting for the transaction. The data is padded according to public key cryptography standards (PKCS) #1, which defines the format of RSA encryption and cryptography standard, standard to form the data block for encryption.

Server Seed + Sensitive DATA, Eg PIN Block + PAD CHAR

The above formatted data block (data field can be in any order) is then processed:

1. for RSA OAEP standard, the client seed is first encoded with the data block and then encrypted with the RSA public key.

2. for standard RSA, no client seed is used for encoding. The data block is encrypted using the RSA public key.

IV. Server Processing (Applications Server)

Upon receiving of the message with the encrypted data 42, the secured mobile payment system application server collaborates with the HSM to validate that the transaction is authentic by locating the transaction status using the transaction identifier in the message; marking the transaction status as received (ensure no duplicate); decrypt and decode the encrypted data using OAEP-RSA or standard RSA; verify that the client seed is indeed used to encode and/or pad the sensitive data (for OAEP-RSA); checking that the server seed stored in the application server's database matches the server seed that is derived from the encrypted message (ensure no tampering with data); and if all the above are in proper order, the HSM 26 forms the PIN block 52 and encrypt the PIN block using the financial institution's/bank's key; and deleting the server seed to ensure no replay of sensitive data.

An embodiment of the secured mobile payment system implementation guarantees that the user's PIN is encrypted upon input into midlet and is transmitted securely over the transmission channel; no duplicate of message (transaction identifier); no tampering of secured data (server seed as part of the encrypted data); no replay of message (no retention of server seed); and no security gap—the sensitive data is processed using HSM.

In summary, midlet is able to provide end to end security using RSA encryption and PIN translation with anti-replay attack, tampering proof, and data integrity protect of the encrypted message. Optionally, the midlet supports OAEP-RSA standard for additional cycle of data encoding using random client seed.

V. User Authentication

User authentication is to ensure that that transaction is initiated by an authorized and valid user. User authentication by the application server may be implemented using, for example, any or all of the following: log into midlet using a user ID and password which can be verified by the application server or financial institution/bank host; 3G/3.5G/GPRS—2^{nd} factor authentication using the phone number that is tagged by the service provider in the GPRS/3G/3.5G message header and verify against the valid user, for example the phone number of the user or the like, database in the application server; and/or SMS—2^{nd} factor authentication using the phone number that is tagged by the service provider in the SMS message header and verified against the valid user, for example by phone number or the like, database in the application server.

VI. Session Authentication

Session authentication is used to prevent replay attacks. Session authentication is to prevent a hacker from replay a valid transaction captured from the system. This is achieved through the use of a HSM random generated server seed. Once a server seed has been generated and issued to midlet, a timestamp is maintained by the application server. Upon successful authentication by the HSM, the application server checks that the current timestamp has not elapsed from the stored timestamp by a stipulated value, else the session is considered as expired and the transaction is rejected. Upon successful authentication of the server seed's session, that session is marked as expired or deleted, and any further transaction having the same server seed's is considered as invalid session and the transaction is rejected. Each session is also identified by the phone number and transaction identifier.

In an embodiment menu screens or pages depicting the type of services available are defined by extensible markup language (XML) files. XML files with a set of predefined tags are used to define the menu screens which are loaded dynamically by midlet depending on the screen flows.

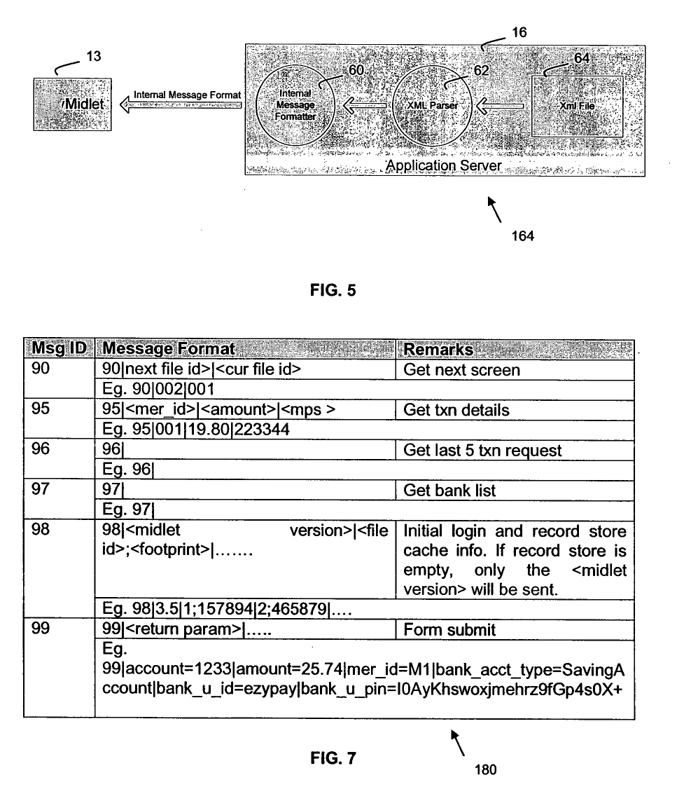

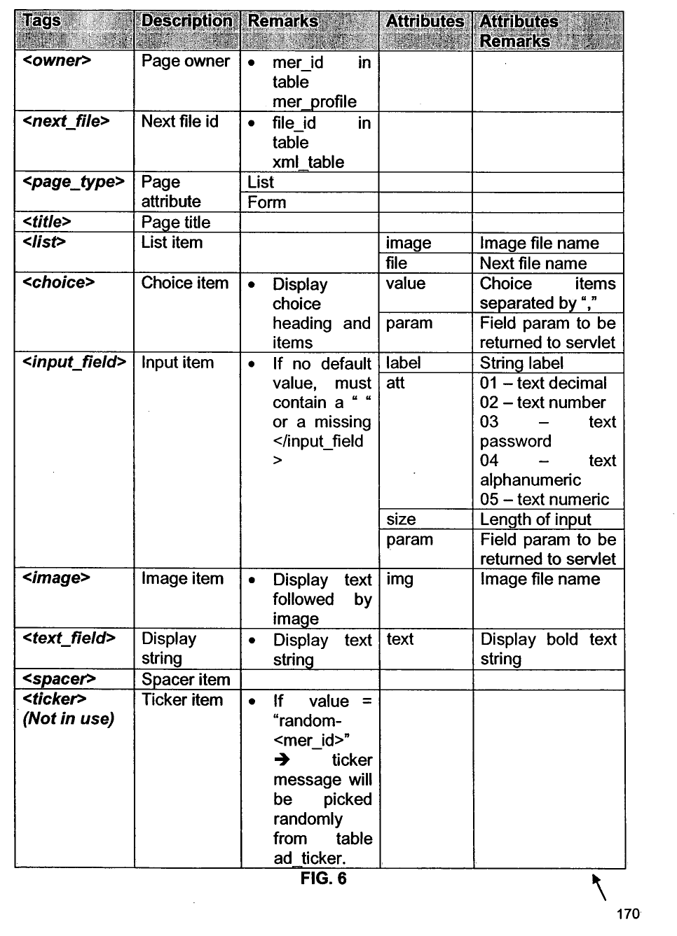

As shown in FIG. 5, the message transformation 164 is shown where the XML files are stored in the application server's database. The application server 16 decides which XML files 64 to retrieve. Using the XML parser 62, the application server parses the XML file and format the XML file with the internal message formatter 60 into an internal message format that is understood by the midlet 12. The tags in the XML files may be defined as shown for example in the table 170 of FIG. 6.

In an embodiment, the internal message format is defined using a string of predefined format as shown in the tables below. Each fields are separated by a “I” character. Each internal message format is identified by a <msg_id> field which is the first field in the message. This is shown in the table 180 in FIG. 7.

VII. Menu Caching and Synchronization

The midlet employs a caching and synchronization technique to cache and store menu pages into the phone's storage and a means to synchronize changes with the latest copy residing on the application server.

A. Caching

Menu screens depicting the type of services available may not be stored within the core of midlet application, but the menu screens may be cached inside the record store of the mobile device, such as a mobile telephone, for subsequent retrieval. This provides a cost efficient and fast method in loading of the screen flow for midlet.

For menu screens that cannot be cached, for example, those that are required to display dynamic data from the database, are dynamically dished out over the air by the application server. This may be done only on an on-demand basis for cost efficiency.

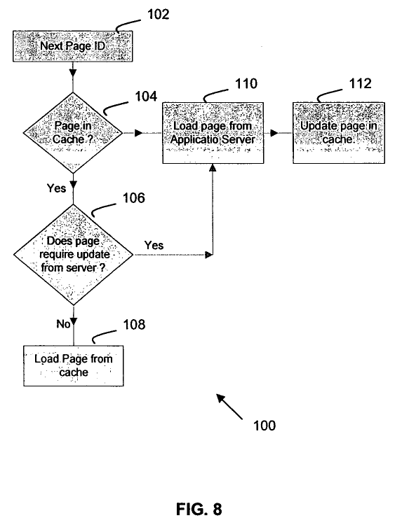

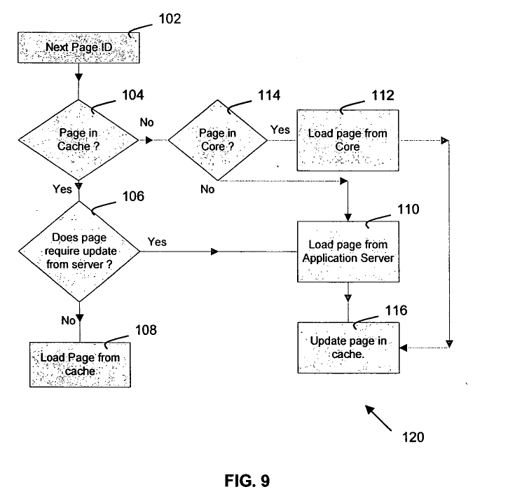

Caching and synchronization of an embodiment of the system is shown in FIG. 8 and may involve during initial startup, the midlet conducts a page synchronization with the application server 16. This is done by informing the application server on the pages that are currently cached in the phone and the footprint of the respective cached pages.

The application server compares the footprint or page ID of the pages with the server copy and notify midlet on the pages which need to be refreshed. The next page ID 102 is received and checked whether in cache 104. The midlet does not load the page immediate but flags an update indicator 106 that the page needs to be updated from the application server 106. The pages are only refreshed on a when need to basis. That is, when the user next access that particular page.

When the midlet needs to access a page, the midlet first checks whether the page has been cached in the record store 104. If the page is cached and the update indicator is false, the midlet loads the cached page 108, and if the page is cached and the update indicator is true, midlet loads the page from the application server 110 and replace the cache with the newly loaded page 112 and reset the update indicator to false; and if the page is not cached at all, midlet loads 110 the page from the application server and cached the page for subsequent usage.

In an embodiment, the number of pages that the midlet can cache may be pre defined, for example set at 20. In cases whereby the cache is full, the midlet may override the page with the longest interval since last visit.

In another embodiment, for example for midlet in SMS mode 120, a variation of the above embodiment is used as shown in FIG. 9. Instead of midlet doing an automated synchronization with the server upon startup, the synchronization is manually triggered by the user through a menu item in an interface on the mobile device. For example, a set of 20 pages may be stored in the core of midlet. When a page needs to be accessed, midlet first checks if the page, next page ID 102, has been cached in the record store 104. If the page is cached and the update indicator is false, midlet loads the cached page 108. If the page is cached and the update indicator is true, the midlet loads the page from the application server 110 and replaces the cache with the newly loaded page 116 and reset the update indicator to false. If the page is not cached at all, the midlet checks if the page exists in the core of midlet 114. If the page exists in the core of the midlet, the midlet loads the page from the core 112 into the cache and displays the page. Else the midlet loads the page from the application server 110 as discussed above and caches the page 116 for subsequent usage.

B. Synchronization

As pages are stored in the cache of the mobile device, such as the mobile telephone, synchronization is necessary in order for midlet to load the latest and updated pages from the application server.

In 3G/3.5G/GPRS mode, synchronization between midlet and the application server is mandatory upon startup, as described above with reference to FIG. 8. However in SMS mode, the synchronization between midlet and the application server could be a manual action as described above with reference to FIG. 9 which is triggered by the user or only upon access of the information which is out of sync with that of the server.

Each XML page is identified by the page identification. A footprint of the XML page is generated by the application server, once there are any changes to the file, to maintain the version of the XML file. A footprint is generated, for example the footprint may be made up of six integers which may be derived for example from the last modified date of the XML file.

In the synchronization process, the midlet sends the page identification, for all the pages stored in the cache of the mobile device 12, and their corresponding footprints to the application server. The application server 16 makes a comparison of each of the page footprint with the respective copy in the server database. The application server in turn sends the midlet the page ID for those pages that have been updated and their latest footprint. The midlet then updates the page indicators on whether an update is required on the next page retrieval.

Using the midlet's caching and synchronization technique, traffic between the midlet and the application server may be reduced which results in cost efficiency and fast loading of pages. As only pages that are visited are cached and synchronized, there is limited wastage in terms of page redundancy

Additionally, in an embodiment, to provide for a seamless and integrated user experience, midlet is configured to be able to be triggered/activated by an incoming SMS. This is achieved by having midlet polling for SMS on, for example, port 8200 or 8500. The SMS sent by the application server to trigger the midlet to activate and display certain pages upon receiving of the SMS has to be sent to either of these two ports in the recipient phone.

The devices and subsystems of the exemplary methods and systems described with respect to FIG. 1-9 can communicate, for example, over a communication network, and may include any suitable servers, workstations, personal computers (PCs), laptop computers, handheld devices, with visual displays and/or monitors, telephones, cellular telephones, wireless devices, PDAs, internet appliances, set top boxes, modems, other devices, and the like, capable of performing the processes of the disclosed exemplary embodiments. The devices and subsystems, for example, may communicate with each other using any suitable protocol and may be implemented using general computer systems and the like. One or more interface mechanisms may be employed, for example, including internet access, telecommunications in any suitable form, such as voice, modem, wireless communications media, and the like. Accordingly, such networks may include, for example, wireless communications networks, cellular communications network, public switched telephone networks (PSTNs), packet data networks (PDNs), the Internet, hybrid communications networks, combinations thereof, and the like.

It is to be understood that the embodiments, as described with respect to FIG. 1-9 are for exemplary purposes, as many variants of the specific hardware used to implement the disclosed exemplary embodiments are possible.

The exemplary systems described with respect to FIG. 1-9 may be used to store information relating to various processes described herein. This information may be stored in one or more memories, such as hard disk, optical disk, magneto-optical disk, RAM, and the like, of the devices and sub-systems of the embodiments. One or more databases of the devices and subsystems may store the information used to implement the exemplary embodiments. The databases may be organized using data structures, such as records, tables, arrays, fields, graphs, trees, lists, and the like, included in one or more memories, such as the memories listed above.

All or a portion of the exemplary systems described with respect to FIG. 1-9 may be conveniently implemented using one or more general-purpose computer systems, microprocessors, digital signal processors, micro-controllers, and the like, programmed according to the teachings of the disclosed exemplary embodiments. Appropriate software may be readily prepared by programmers of ordinary skill based on the teachings of the disclosed exemplary embodiments. In addition, the exemplary systems may be implemented by the preparation of application-specific integrated circuits or by interconnecting an appropriate network of component circuits.

Advantageously, the exemplary embodiments described herein may be employed in offline systems, online systems, and the like, and in applications, such as TV applications, computer applications, DVD applications, VCR applications, appliance applications, CD play applications, and the like.

Whilst there has been described in the foregoing description preferred embodiments of the present invention, it will be understood by those skilled in the technology concerned that many variations or modifications in details of design or construction may be made without departing from the present invention.

1. A method for end-to-end secure data transfer between a mobile device of a user and a server via an insecure network to a target domain, the method comprising:
generating a dynamic key and a seed exchange and management during a transaction between the user and the target domain;
authenticating the user of the mobile device in a transaction authentication;
generating a server key at an application server comprising a server seed and a server-device key-pair dynamically generated from a server domain;
transmitting the device key to the mobile device;
receiving data input from the user at the mobile device;
dynamically generating a client seed at the mobile device and encrypting the data input with device key, encoded and/or padded with the client seed at the mobile device and transmitting the encrypted data input with the client seed to the application server;
decrypting the encrypted data input using server key; and
translating the decrypted data input using a target key within a hardware security module without exposing the encrypted data input to the network and transmitting the translated data input to the target domain.

2. The method of claim 1 further comprising
downloading a midlet from the server to the mobile device; and
dynamically generating a second server seed at the server; and loading the midlet with the second server seed and a transaction identifier.

3. (canceled)

4. The method of claim 1 further comprising, using a pre-loaded set of keys or generating a static public key with validity periods between the user and an established target institution.

5. The method of claim 4 further comprising a SMS channel.

6. The method of claim 2 further comprising loading the user key onto the midlet upon input of the encrypted data to the midlet, wherein the user key is an RSA public key.

7. The method of claim 2 wherein the server seed and the transaction identifier are session based.

8. The method of claim 2 wherein authenticating the user comprises locating the transaction status of the transaction identifier.

9. The method of claim 1 further comprising generating a dynamic client seed and verifying the client seed is with the encoded data over the session period.

10. The method of claim 2 further comprising checking whether the second server seed stored in the server matches the server seed derived from the encrypted data.

11. The method of claim 1 further comprising synchronizing the midlet of the mobile device with the server and informing the server of page information and cached pages on mobile device; and generating a page footprint for updating uncached pages.

12. The method of claim 11 wherein the midlet is in SMS mode and the synchronizing is instigated upon page access or by a user manual activation.

13. A system for end-to-end secure data transfer between a mobile device of a user and a server via an insecure network to a target domain, the system comprising:
an authenticating module in the server configured to authenticate a user of the mobile device in a transaction authentication, and a key module configured to generate a dynamic key and a seed exchange and management during a transaction between the user and the target domain;
a server key module configured to generate a dynamic server key at an application server comprising a dynamic server seed and a server-device key-pair entered from the target domain and configured to transmit the device key to the mobile device;
a data input module configured to receive data input from the user at the mobile device;
an encrypting module configured to generate a client seed at the mobile device and encrypting the data input with the device key, encoded and/or padded with client seed at the mobile device and configured to transmit the encrypted data input with the client seed to the application server;
a decrypting module on the application server configured to decrypt the encrypted data input using the server key; and
a translator configured to translate the decrypted data input using a target key within a hardware security module without exposing the encrypted data input to the network and configured to transmit the translated data input to the target domain.

14. The system of claim 13 further comprising a downloading module configured to download a midlet from the server to mobile device;
and a seed module within the server to configured to generate a second server seed, and configured to load the midlet with the second server seed and a transaction identifier.

15. The system of claim 13 wherein the authenticating module comprises the key module configured to generate the dynamic key and the seed exchange and management during the transaction between the user and a established target institution, wherein the key module is further configured to enable a telco agnostic with multiple secured domains from a single mobile client application to established target institutions.

16. The system of claim 13 wherein the key module further comprises a pre-loaded set of keys or a static public key with validity periods between the user and established target institution.

17. The system of claim 16 further comprising a SMS channel.

18. The system of claim 14 wherein the user key is an RSA public key, and wherein the seed module is further configured to load the user key onto the midlet at input of the encrypted data at the midlet.

19. The system of claim 14 wherein the server seed and the transaction identifier are session based.

20. The system of claim 14 wherein the authenticating module authenticates the user by locating the transaction status of the transaction identifier.

21. The system of claim 13 wherein the authenticating module is further configured to generate a dynamic client seed; and verifying the client seed is with the encoded data over the session period.

22. The system of claim 14 wherein the authenticating module is further configured to check whether the second server seed stored in the server matches the server seed derived from the encrypted data.

23. The system of claim 13 further comprising a synchronizing module configured to synchronize the midlet of the mobile device with the server, and configured to inform the server of page information of cached pages on mobile device, and configured to generate a page footprint for updating uncached pages.

24. The system of claim 23 wherein the midlet is in SMS mode and the synchronizing is instigated upon the page access or by a user manual activation.

25. A midlet for enabling a system for end-to-end secure data transfer between a mobile device of a user and an application server via an insecure network to a target domain, the midlet for downloading from the server to the mobile device, comprising:
a server interface configured to interface with the server and a user interface configured to interface with the user of the mobile device, an authenticating module configured to authenticate the user of the mobile device in a transaction authentication and generating a dynamic key and a seed exchange and management during a transaction between the user and the target domain, and configured to communicate with a server key module configured to dynamically generate a server key at the application server comprising a server seed and a server-device key-pair generated from the server domain, and configured to transmit the device key to the mobile device via the midlet;
the user interface further configured to receive at a data input module data input from the user at the mobile device;
the server interface further configured to enable an encrypting module configured to dynamically generate a client seed at the mobile device and configured to encrypt the data input with device key, encode and/or padded with client seed at the mobile device and configured to transmit the encrypted data input with client seed to the application server, and a decrypting module on the application server configured to decrypt the encrypted data input using server key; and
a translator module on the application server configured to translate the decrypted data input using target key within a hardware security module without exposing the encrypted data input to the network and configured to transmit the translated data input to the target domain.
